(19) United States
(12) Patent Application Publication
(10) Pub. No.: US 2016/0110761 A1
(43) Pub. Date: Apr. 21, 2016

(54) FINDING THE SPACE SPANNED BY USER PROFILES FROM BINARY FEEDBACK

(71) Applicants: Efstratios Ioannidis, San Francisco, CA (US); Yuekai Sun, Millbrae, CA (US); Andrea Montanari, Sunnyvale, CA (US)

(72) Inventors: Efstratios Ioannidis, San Francisco, CA (US); Yuekai Sun, Millbrae, CA (US); Andrea Montanari, Sunnyvale, CA (US)

(21) Appl. No.: 14/514,844

(22) Filed: Oct. 15, 2014

(51) Int. Cl. G06Q 30/02

(52) U.S. Cl. CPC G06Q 30/0255

(57) ABSTRACT

Finding the space spanned by user profiles of consumed items for making recommendations commences by first estimating a mean and covariance for a set of labeled items associated with a profile. Thereafter, a vector is identified that belongs to a convex cone spanned by the user profiles based on the estimated mean and covariance, the labels and items. The labels are mirrored in a negative space defined by the identified vector. The weighted covariance matrix is computed based on the mirrored labels; and eigenvalues and eigenvectors are computed of the weighted covariance matrix. A first set of eigenvalues share a value and wherein a remainder of the eigenvalues correspond to eigenvectors that span the profile.

### CROSS-REFERENCE TO RELATED APPLICATIONS

This application claims priority under 35 U.S.C. 119(e) to U.S. Provisional Patent Application Ser. No. 61/898,507, filed Nov. 1, 2013 and U.S. Provisional Patent Application Ser. No. 61/985,034, filed Apr. 28, 2014, the teachings of which are incorporated herein.

### TECHNICAL FIELD

The present principles relate to providing recommendations based on user behavior. More particularly, the present principles relates to using binary user feedback to determine information about specific users who share an account.

### BACKGROUND ART

On-line commerce providers provide personalized recommendations for items by collecting user ratings about items ordered previously. Such items can constitute virtually any variety of goods or services, but only audio-visual content, and specifically movies, are considered herein for the sake of simplicity. Typically, multiple individuals within a single household (family members, roommates, etc.) may share a common account associated with delivery of movies for both viewing and rating. Content Providers who deliver movies on-line reluctantly deploy multiple accounts because users typically perceive log-in screens as a nuisance and a barrier to ordering and rating movies. This is especially true on devices lacking a keyboard, such as televisions or gaming platforms, where the entry of a password can prove difficult and time-consuming. Account sharing persists even when content providers offer the option of registering secondary accounts, as the latter typically have access to a subset of the services enjoyed by the primary account holder. Finally, such users may regard sharing as a partial (if unconscious) privacy protection mechanism, as users might not want to release the household composition and demographics.

The use of a single account by multiple individuals poses a challenge to providing accurate personalized recommendations. Informally, the recommendations provided to a “composite” account holder often result from ratings of two or more dissimilar users and may not match the interests of any single user. Moreover, recommendation methods relying on low-rank assumptions (such as matrix factorization) can fail when relying on data derived from a composite of individual users. Such a failure can arise because “mixing” entries from different rows of a low-rank matrix results in a matrix that need not be low-rank. Beyond personalized recommendations, the ability to differentiate among individual users has value as it can aid in determining the household's demographics. Such information can be subsequently monetized through, e.g., targeted advertising.

Past recommendation techniques have focused on identifying the users of an account from the users' ratings. However, such existing techniques cannot provide a solution to this problem where the feedback is binary (e.g., −1 if a movie is not watched; +1 if it is), instead relying on the users to select from a range of values. One existing approach makes use of the principal Hessian directions (pHd) method. The pHd approach uses dimensionality reduction and data visualization by generalizing principal component analysis to the regression (discriminative) setting. Unfortunately, the pHd approach fails in general for the mixture models of interest in the present case.

### BRIEF SUMMARY OF THE PRESENT PRINCIPLES

In accordance with first preferred embodiment of the present principles, a method for providing recommendations of items based on user behavior commences by first tracking user which items offered to users were purchased. This behavior for each is stored in a user profile. The span of the user profiles is determined from which recommendations for items can be made.

According to another aspect of the present principles, a method for finding the space spanned by user profiles commences by estimating a mean and covariance for a set of labeled items associated with a user profile; identifying a vector that belongs to a convex cone spanned by the user profiles based on the estimated mean and covariance, the labels and items; mirroring the labels in a negative space defined by the identified vector; computing a weighted covariance matrix based on the mirrored labels; and computing eigenvalues and eigenvectors of the weighted covariance matrix, wherein a first set of eigenvalues share a value and wherein a remainder of the eigenvalues correspond to eigenvectors that span the profile.

According to another aspect of the present principles, a system for finding the space spanned by user profiles includes a storage device configured to store a set of labeled items associated with a user profile; and a processor configured to estimate a mean and covariance for the set of labeled items, to identify a vector that belongs to a convex cone spanned by the user profiles based on the estimated mean and covariance, the labels and items, to mirror the labels in a negative space defined by the identified vector, to compute a weighted covariance matrix based on the mirrored labels, and to compute eigenvalues and eigenvectors of the weighted covariance matrix, wherein a first set of eigenvalues share a value and wherein a remainder of the eigenvalues correspond to eigenvectors that span the profile.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram of a streaming network that delivers personalized content in accordance with the present principles;

FIG. 2 is a diagram of a system that delivers personalized content in accordance with the present principles;

FIG. 3 is a diagram of a touch screen interface in accordance with the present principles;

FIG. 4 is a diagram of gestural controls in accordance with the present principles; and

FIG. 5 is a block/flow diagram of a method for finding a number of users associated with a profile and their span in accordance with the present principles.

### DETAILED DESCRIPTION

The present principles are directed to determining the span of the user profiles of a single account based on binary feedback. Embodiments of the present invention identify composite accounts within, e.g., a movie delivery system, and furthermore identify the individuals sharing such an account to learn accurate profiles of different users' behaviors.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

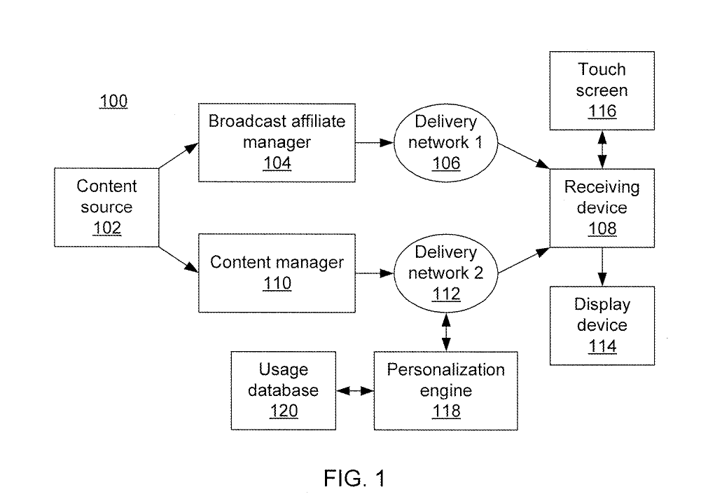

Referring now to FIG. 1, a block diagram is shown of a system 100 for delivering content to a home or end user in connection with determining user information and profiles. The content originates from a content source 102, such as a movie studio or production house. The content may be supplied in at least one of two forms. One form may be a broadcast form of content. The broadcast content is provided to the broadcast affiliate manager 104, which is typically a national broadcast service. The broadcast affiliate manager may collect and store the content, and may schedule delivery of the content over a deliver network, shown as a first delivery network 106. The first delivery network 106 may include satellite link transmissions from a national center to one or more regional or local centers. The first delivery network 106 may also include local content delivery using local delivery systems such as over-the-air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include content delivered as premium viewing, pay-per-view, or other content not otherwise provided to the broadcast affiliate manager such as, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, second delivery network 112. The second delivery network 112 may include high-speed broadband Internet type communications systems. It is important to note that the content from the broadcast affiliate manager 104 may also be delivered using all or parts of the second delivery network 112 and content from the content manager 110 may be delivered using all or parts of the first delivery network 106. In addition, the user may also obtain content directly from the Internet via the second delivery network 112 without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

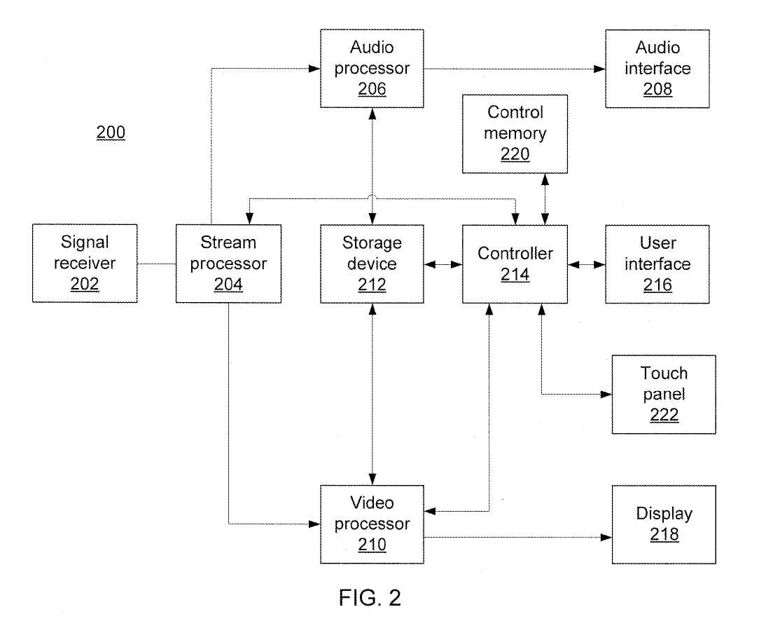

The receiving device 108 may receive different types of content from one or both of the delivery networks. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a display device 114. The display device 114 may be a conventional 2-D type display or may alternatively be an advanced 3-D display.

The receiving device 108 may also be interfaced to a second screen such as a touch screen control device 116. The touch screen control device 116 may be adapted to provide user control for the receiving device 108 and/or the display device 114. The touch screen device 116 may also be capable of displaying video content. The video content may be graphics entries, such as user interface entries, or may be a portion of the video content that is delivered to the display device 114 The touch screen control device 116 may interface to receiving device 108 using any well-known signal transmission system, such as infra-red (IR) or radio frequency (RF) communications and may include standard protocols such as infra-red data association (IRDA) standard, Wi-Fi, Bluetooth and the like, or any other proprietary protocols.

In the example of FIG. 1, the system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118. In the present example, the back end server 118 (as well as the usage database 120) is connected to the system the system 100 and accessed through the second delivery network 112.

Referring now to FIG. 2, a block diagram of an embodiment of a receiving device 200 is shown. Receiving device 200 may operate similar to the receiving device described in FIG. 1 and may be included as part of a gateway device, modem, set-top box, or other similar communications device. The device 200 shown may also be incorporated into other systems including an audio device or a display device. In either case, several components necessary for complete operation of the system are not shown in the interest of conciseness, as they are well known to those skilled in the art. In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary, a conversion of the video content based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, originating either from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 can generate the various screens for presenting the search results in a three dimensional gird as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the gird display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory may also store a database of elements, such as graphic elements containing content. The database may be stored as a pattern of graphic elements. Alternatively, the memory may store the graphic elements in identified or grouped memory locations and use an access or location table to identify the memory locations for the various portions of information related to the graphic elements. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

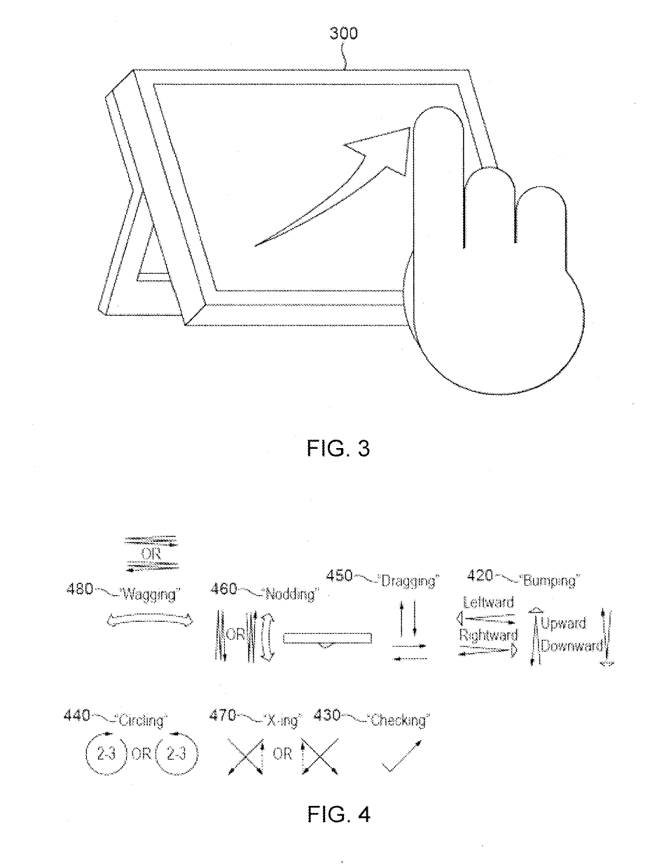

Referring now to FIG. 3, the user interface process of the present disclosure employs an input device that can be used to express functions, such as fast forward, rewind, etc. To allow for this, a tablet or touch panel device 300 (which is the same as the touch screen device 116 shown in FIG. 1) may be interfaced via the user interface 216 and/or touch panel interface 222 of the receiving device 200. The touch panel device 300 allows operation of the receiving device or set top box based on hand movements, or gestures, and actions translated through the panel into commands for the set top box or other control device. In one embodiment, the touch panel 300 may simply serve as a navigational tool to navigate the grid display. In other embodiments, the touch panel 300 will additionally serve as the display device allowing the user to interact directly with the navigation through the grid display of content. The touch panel device may be included as part of a remote control device containing more conventional control functions such as activator buttons. The touch panel 300 can also include at least one camera element. As described in further detail below, content displayed on the touch panel device 300 may be zapped or thrown to the main screen (e.g., display device 114 shown in FIG. 1).

Referring now to FIG. 4, the use of a gesture sensing controller or touch screen, such as that shown above, provides for a number of types of user interaction. The inputs from the controller are used to define gestures and the gestures, in turn, define specific contextual commands. The configuration of the sensors may permit defining movement of a user's fingers on a touch screen or may even permit defining the movement of the controller itself in either one dimension or two dimensions. Two-dimensional motion, such as a diagonal, and a combination of yaw, pitch and roll can be used to define any 4-dimensional motion, such as a swing. A number of gestures are illustrated in FIG. 4. Gestures are interpreted in context and are identified by defined movements made by the user.

Bumping 420 is defined by a two-stroke drawing indicating pointing in one direction, either up, down, left or right. The bumping gesture is associated with specific commands in context. For example, in a Time Shifting mode, a left-bump gesture 420 indicates rewinding, and a right-bump gesture indicates fast-forwarding. In other contexts, a bump gesture 420 is interpreted to increment a particular value in the direction designated by the bump. Checking 440 is defined as in drawing a checkmark. It is similar to a downward bump gesture 420. Checking is identified in context to designate a reminder, user tag or to select an item or element. Circling 440 is defined as drawing a circle in either direction. It is possible that both directions could be distinguished. However, to avoid confusion, a circle is identified as a single command regardless of direction. Dragging 450 is defined as an angular movement of the controller (a change in pitch and/or yaw) while pressing a button (virtual or physical) on the tablet 300 (i.e., a “trigger drag”). The dragging gesture 450 may be used for navigation, speed, distance, time-shifting, rewinding, and forwarding. Dragging 450 can be used to move a cursor, a virtual cursor, or a change of state, such as highlighting outlining or selecting on the display. Dragging 450 can be in any direction and is generally used to navigate in two dimensions. However, in certain interfaces, it is preferred to modify the response to the dragging command. For example, in some interfaces, operation in one dimension or direction is favored with respect to other dimensions or directions depending upon the position of the virtual cursor or the direction of movement. Nodding 460 is defined by two fast trigger-drag up-and-down vertical movements. Nodding 460 is used to indicate “Yes” or “Accept.” X-ing 470 is defined as in drawing the letter “X.” X-ing 470 is used for “Delete” or “Block” commands. Wagging 480 is defined by two trigger-drag fast back-and-forth horizontal movements. The wagging gesture 480 is used to indicate “No” or “Cancel.”

Depending on the complexity of the sensor system, only simple one-dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left right movement may be placed in one spot and used for volume u/down, while a vertical sensor for up down movement may be place in a different spot and used for channel up/down. In this way, specific gesture mappings may be used. As discussed in further detail below, a two finger swipe gesture may be utilized to initiate the throwing or moving of content from the tablet 300 to the main screen or display device 114.

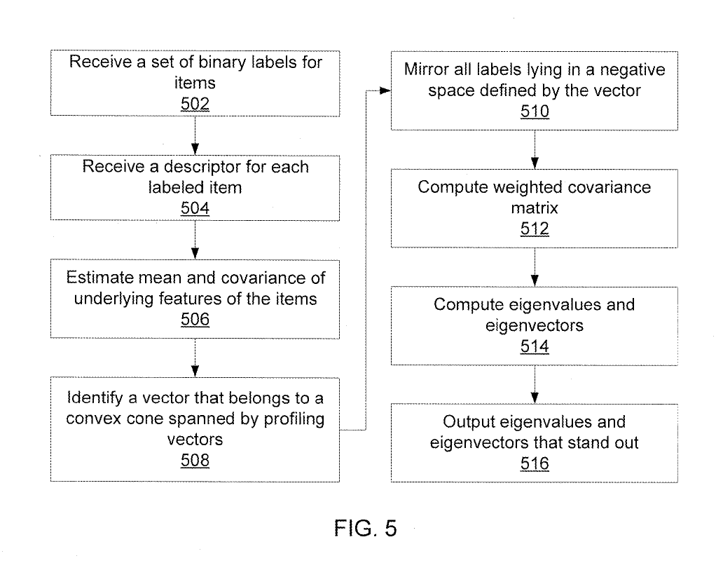

Referring now to FIG. 5, a method is shown that may be implemented by, e.g., a content distribution service, an online market service, etc. (e.g., content manager 110 or the broadcast affiliate manager 104) to ascertain information about multiple users associated with a single account using binary feedback information.

Block 502 receives a set of binary labels as an input. These labels are provided by one or more users sharing an account and are associated with a set of items. For example, the items in question may be movies, and the labels can indicate whether the account has viewed these movies or not. Alternatively, the items could be products advertised to the account and the labels may indicate whether the account purchased the products or not. The label for an item i is denoted herein as yᵢ.

Block 504 receives a set of item descriptors, one of each of labeled item. These descriptors could be, e.g., vectors describing the genre or actors participating in a movie or other features of the product advertised. This feature descriptor may be represented as a vector of real-valued numbers of dimension d (where d is the number of features). The descriptor of item i will be shown herein as xᵢ.

Using this information, block 506 estimates the mean and covariance of the underlying features xᵢ. To do this, block 506 constructs estimates of the feature mean and covariance over the features and labels. A standard Gaussian version of the features may then be constructed as \hat{Σ}^{-1/2}(Xᵢ−\hat{μ}), where \hat{Σ} is the covariance and \hat{μ} is the feature mean.

Using the calculated estimates, block 508 identifies a vector r that belongs to a convex code spanned by the vectors profiling each user. The vector may be calculated as

$$r = \frac{1}{⌊ n / 2 ⌋} {\sum }_{i = 1}^{⌊ n / 2 ⌋} {Y}_{i} {\hat{Σ}}^{- \frac{1}{2}} ( {X}_{i} - \hat{μ} ) ,$$

where n is the number of labels, and this vector lies in the interior of the convex cone spanned by the parameter profiles. The vector r may then be used to perform a mirroring operation, where all labels lying in the negative half space determined by r are flipped, for example by changing +1 to −1 and −1 to +1 in block 510. The flipped labels are denoted herein by Zᵢ.

Block 512 computes a weighted covariance matrix Q over all xᵢ, where each point's contribution is weighed by the mirrored labels. The matrix Q is determined as

$$Q = \frac{1}{⌈ \frac{n}{2} ⌉} {\sum }_{i = ⌊ n / 2 ⌋ + 1}^{n} {Z}_{i} {\hat{\sum }}^{- \frac{1}{2}} ( {X}_{i} - \hat{μ} ) {( {X}_{i} - \hat{μ} )}^{T} {\hat{\sum }}^{- \frac{1}{2}} .$$

The spectrum of Q has a specific structure that reveals the span of the users. In particular, Q converges to a matrix that contains an eigenvalue with multiplicity n-k, where n is the number of labels and k is a number of remaining eigenvalues.

Block 514 calculates eigenvectors and eigenvalues of the matrix Q. Most eigenvalues of Q will be equal to each other (i.e., a number of eigenvalues having multiplicity n-k), but a small number of eigenvalues will differ. The standout eigenvalues are calculated by finding the median value of all the eigenvalues and identifying the k values furthest from the median. The number of eigenvalues that “stand out” in this respect is interpreted as being a number of users associated with the account. The eigenvectors corresponding to the stand-out eigenvalues yield the span of the user profiles. Block 516 rotates the eigenvectors by multiplying by to obtain the span and outputs these quantities. The resulting span is a set of vectors that are in the subspace defined by all linear combinations of the vectors.

The span output by block 516 can be used for several tasks. For example, the span may be used to predict a label for an item given a new feature vector (in other words, predicting whether a user would watch this movie). The span may also be used for clustering, allowing the content provider to identify which user associated with an account generated a particular label. Any algorithm that does either clustering or prediction will run with improved accuracy if one first projects the features to the span defined by profiles. Using such information allows the content provider to make a recommendation using well known techniques. For example, if a user choose a movie with a certain actor, the content provider could recommend other movies with that actor.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for providing recommendations of items based on user behavior, comprising:
tracking user which items offered to users were purchased,
storing user purchasing behavior in a user profile, and
determining a span of user profiles; and
making item recommendations based of the span of user profiles.

2. A method for finding the space spanned by user profiles, comprising:
estimating a mean and covariance for a set of labeled items associated with a profile;
identifying a vector that belongs to a convex cone spanned by the user profiles based on the estimated mean and covariance, the labels and items;
mirroring the labels in a negative space defined by the identified vector;
computing a weighted covariance matrix based on the mirrored labels; and
computing eigenvalues and eigenvectors of the weighted covariance matrix, wherein a first set of eigenvalues share a value and wherein a remainder of the eigenvalues correspond to eigenvectors that span the profile.

3. The method of claim 2, wherein a number of the remainder eigenvalues corresponds to a number of users associated with the profile.

4. The method of claim 2, wherein the labeled items are labeled according to a binary label.

5. The method of claim 4, wherein mirroring comprises flipping a binary value of labels in the negative space.

6. The method of claim 2, further comprising one of clustering or predicting using the eigenvectors that span the profile.

7. The method of claim 2, further comprising rotating the eigenvectors that span the profile by multiplying them with a covariance matrix.

8. A system for finding the space spanned by user profiles, comprising:
a storage device configured to store a set of labeled items associated with a user profile; and
a processor configured to estimate a mean and covariance for the set of labeled items, to identify a vector that belongs to a convex cone spanned by the user profiles based on the estimated mean and covariance, the labels and items, to mirror the labels in a negative space defined by the identified vector, to compute a weighted covariance matrix based on the mirrored labels, and to compute eigenvalues and eigenvectors of the weighted covariance matrix, wherein a first set of eigenvalues share a value and wherein a remainder of the eigenvalues correspond to eigenvectors that span the profile.

9. The system of claim 8, wherein a number of the remainder eigenvalues corresponds to a number of users associated with the profile.

10. The system of claim 8, wherein the labeled items are labeled according to a binary label.

11. The system of claim 10, wherein the processor is configured to mirror by flipping a binary value of labels in the negative space.

12. The system of claim 8, wherein the processor is further configured to cluster or predict using the eigenvectors that span the profile.

13. The system of claim 8, wherein the processor is further configured to rotate the eigenvectors that span the profile by multiplying them with a covariance matrix.

14. A non-transitory computer readable storage medium comprising a computer readable program for finding the space spanned by user profiles, wherein the computer readable program when executed on a computer causes the computer to perform the steps of:
estimating a mean and covariance for a set of labeled items associated with a profile;
identifying a vector that belongs to a convex cone spanned by the user profiles based on the estimated mean and covariance, the labels and items;
mirroring the labels in a negative space defined by the identified vector;
computing a weighted covariance matrix based on the mirrored labels; and
computing eigenvalues and eigenvectors of the weighted covariance matrix, wherein a first set of eigenvalues share a value and wherein a remainder of the eigenvalues correspond to eigenvectors that span the profile.
